(19) United States
(12) Patent Application Publication
(10) Pub. No.: US 2024/0395280 A1
(43) Pub. Date: Nov. 28, 2024

(54) METHOD, SYSTEM AND COMPUTER-READABLE STORAGE MEDIUM FOR CROSS-TASK UNSEEN EMOTION CLASS RECOGNITION

(71) Applicant: NATIONAL TSING HUA UNIVERSITY, Hsinchu City (TW)

(72) Inventors: Jeng-Lin LI, Hsinchu City (TW); Chi-Chun LEE, Hsinchu City (TW)

(73) Assignee: NATIONAL TSING HUA UNIVERSITY, Hsinchu City (TW)

(21) Appl. No.: 18/242,859

(22) Filed: Sep. 6, 2023

(30) Foreign Application Priority Data
May 25, 2023 (TW) 112119474

(51) Int. Cl. G10L 25/63; G10L 15/02; G10L 15/06; G10L 15/10

(52) U.S. Cl. CPC G10L 25/63; G10L 15/02; G10L 15/063; G10L 15/10

(57) ABSTRACT

A method for unseen emotion class recognition comprises: receiving, with an emotion recognition model, a speech sample to be tested; calculating, with an encoder, a sample embedding to be tested of the speech sample to be tested; calculating a first distance metric between the sample embedding to be tested and a first registered emotion category representation, and a second distance metric between the sample embedding to be tested and a second registered emotion category representation, wherein the second registered emotion category is not included in a plurality of basic emotion categories; and determining an emotion category of the speech sample to be tested according to the first distance metric and the second distance metric.

### TECHNICAL FIELD

The present invention relates to the technical field of speech emotion recognition. Specifically, the present invention relates to a method, system and computer-readable storage medium for cross-task unseen emotion class recognition.

### BACKGROUND

As artificial intelligence evolves, accomplishing various kinds of recognition (e.g., face recognition, license plate recognition, object recognition, etc.) with artificial intelligence has become a field that is highly valued by the scientific and industrial circles. Human emotion recognition is also an important development of artificial intelligence. Current emotion recognition models can perform processing using image data (e.g., facial expression recognition, etc.), text data (e.g., converting speech into text to judge the meaning of words) and voice data.

Existing speech emotion recognition models mainly contain “cross-emotion-marker” and “cross-database”, the former mainly strengthen the recognition ability adopting “association between emotion categories in intrinsic emotion tasks” or “association between markers”, while the latter mainly adopting the source database to develop the pre-training model and training the new model for the target database with the transfer learning method. However, neither of the above two techniques is suitable for scenarios where the emotional task is changed or the emotional category has not appeared before. In the past, in order to be able to identify unclassified emotional categories in the database, many databases would mark emotion categories with dimensions of activation and valence, but these two dimensions are unable to completely express various emotion categories, and when encountering more complex emotions (such as annoyance), there may be gaps in judgment results due to different scenarios.

Therefore, there is a need for a speech emotion recognition method that can perform cross-task emotion recognition for emotions that have never appeared in the database without retraining the model.

### SUMMARY

One objective of the present invention is to provide a method, system and computer-readable storage medium for cross-task unseen emotion class recognition, which performs speech emotion recognition without collecting images and converting speech into text.

Another objective of the present invention is to provide a method, system and computer-readable storage medium for cross-task unseen emotion class recognition, which can quickly perform new emotion recognition tasks using only a small amount of emotion sample data and without retraining the model when encountering unclassified emotion categories.

In one implementation, a method for unseen emotion class recognition comprises: receiving, with an emotion recognition model, a speech sample to be tested; calculating, with an encoder, a sample embedding to be tested of the speech sample to be tested; calculating a first distance metric between the sample embedding to be tested and a first registered emotion category representation, and a second distance metric between the sample embedding to be tested and a second registered emotion category representation, wherein the second registered emotion category is not included in a plurality of basic emotion categories; and determining an emotion category of the speech sample to be tested according to the first distance metric and the second distance metric.

By this configuration, the distance between the speech sample embedding to be tested and the registered emotion category representation can be calculated with ease, and the registered emotion category closest to the speech sample embedding to be tested be found, further corresponding the speech sample to be tested to the registered emotion category, to accomplish the objective of emotion recognition.

In another implementation, a system for unseen emotion class recognition comprises a memory having stored thereon a plurality of instructions, and a processor coupled to the memory, wherein the processor is configured to, when executing the instructions, perform the method for unseen emotion class recognition of the foresaid embodiment.

In yet another implementation, a computer-readable storage medium for unseen emotion class recognition is loaded with a computer-readable program capable of, after being read by a computer, performing the method for unseen emotion class recognition of the foresaid embodiment.

### BRIEF DESCRIPTION OF THE DRAWINGS

FIG. 1A shows a schematic flow chart of a training procedure of an emotion recognition method of an embodiment of the present invention.

FIG. 1B shows a schematic diagram of a training procedure of an emotion recognition method of an embodiment of the present invention.

FIG. 1C shows a schematic diagram of a training procedure of an emotion recognition method of an embodiment of the present invention.

FIG. 2 shows a simplified schematic diagram of projecting distance metrics of basic emotion categories on a hypersphere in an emotion recognition method of an embodiment of the present invention.

FIG. 3 shows a schematic flow chart of a register procedure of an emotion recognition method of an embodiment of the present invention.

FIG. 4 shows a schematic diagram of a process of registering emotion categories in an emotion recognition method of an embodiment of the present invention.

FIG. 5 shows a schematic flow chart of a verification procedure of an emotion recognition method of an embodiment of the present invention.

FIG. 6 shows a schematic diagram of a process of recognizing a speech sample to be tested of an embodiment of the present invention.

### DETAILED DESCRIPTION

The method, system and computer-readable storage medium for cross-task unseen emotion class recognition of the present invention are illustrated below by describing specific embodiments and accompanying drawings; a person of ordinary skill in the art can understand the technical concepts and effects of the present invention through the present disclosure. However, the contents disclosed below are not intended to limit the scope of the claimed subject matter; a person of ordinary skill in the art can implement the present disclosure in embodiments with different structures, operation sequences, etc., without departing from the principle of the spirit of the present invention.

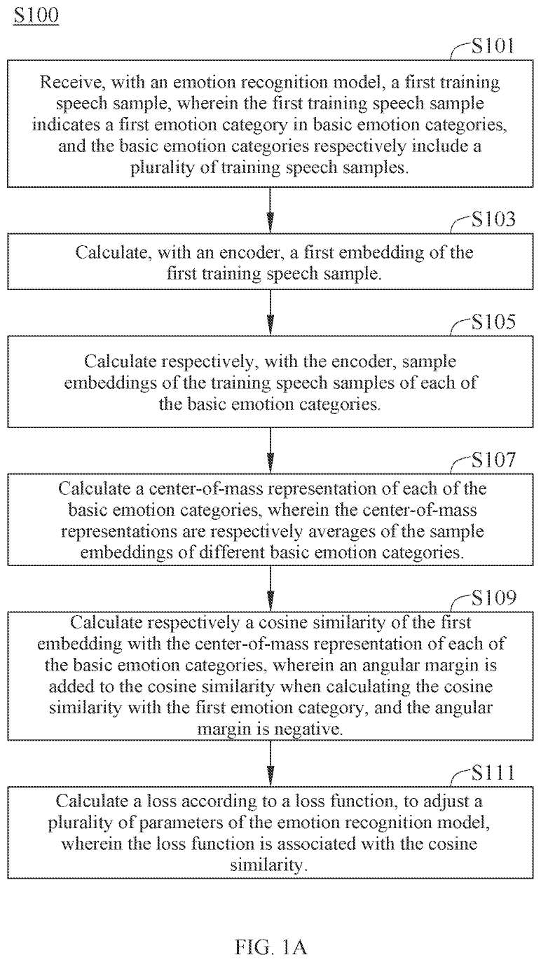

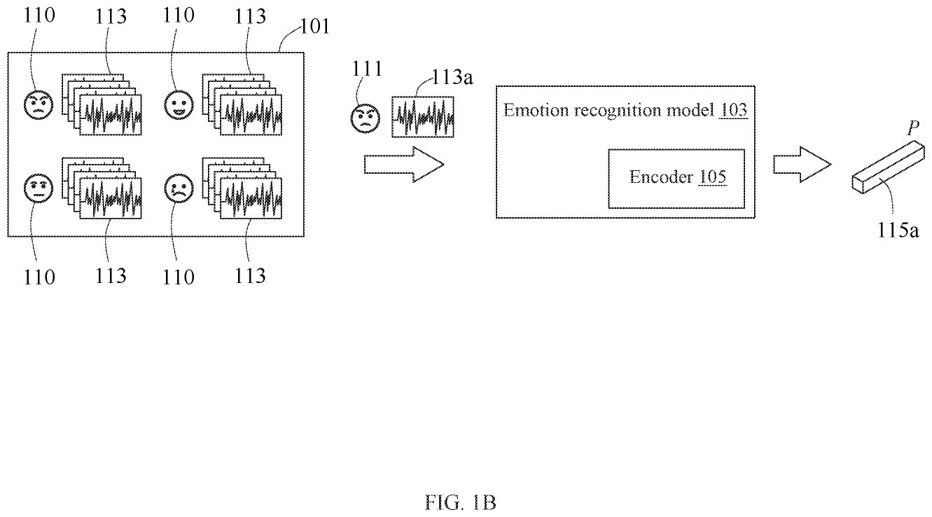

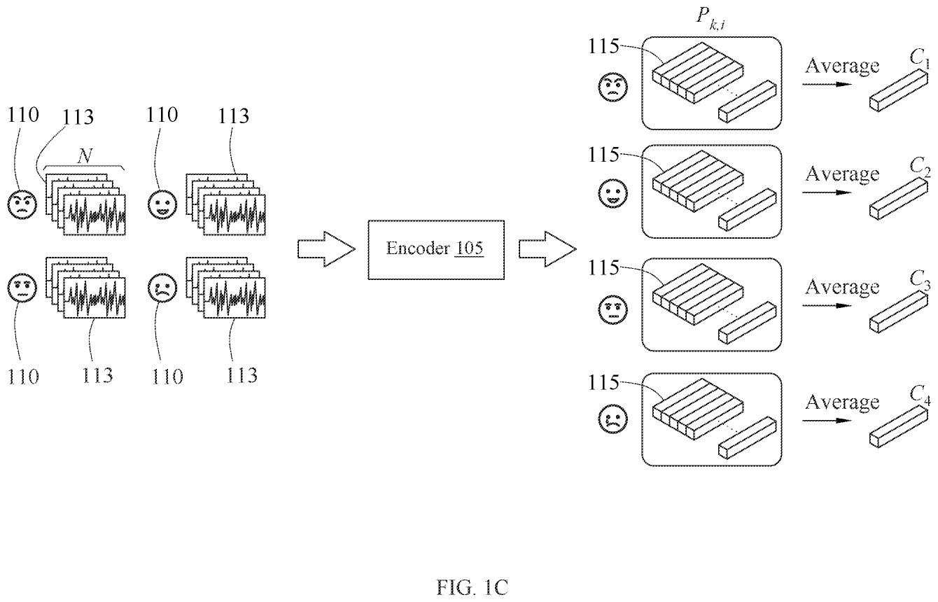

In order to clearly illustrate the contents of the present invention, an emotion recognition method is divided in the present embodiment into three phases, i.e., training procedure, register procedure and verification procedure. Refer to FIG. 1A and FIG. 1B illustrating a training procedure S100 of an emotion recognition method of an embodiment of the present invention. At step S101, the procedure includes receiving, with an emotion recognition model 103, a first training speech sample 113a, wherein the first training speech sample 113a indicates a first emotion category 111 in basic emotion categories 110, and the basic emotion categories 110 include respectively a plurality of training speech samples 113. In the present embodiment, the basic emotion categories 110 can be marked emotion categories in an emotion database 101 (e.g., emotions marked in an IEMOCAP (The Interactive Emotional Dyadic Motion Capture) database, including anger, happiness, neutral and sad, etc.), each of the basic emotion categories 110 having a plurality of training speech samples 113 (i.e., a plurality of speech samples marked as anger, a plurality of speech samples marked as happiness, a plurality of speech samples marked as neutral and a plurality of speech samples marked as sad, etc.). The first emotion category 111 is one emotion in the basic emotion categories 110 (e.g., the first emotion category 111 is anger), and the first training speech sample 113a is a speech sample marked as the first emotion category 111 (e.g., a speech sample marked as anger). It should be noted that the foresaid emotion database 101 and basic emotion categories 110 are exemplary illustrations, other emotion databases 101 (e.g., MELD (Multimodal Emotion Lines Dataset) database) can be used and other kinds of basic emotion categories 110 (e.g., disappointment, fear, etc.) be contained and so on in different embodiments, the present invention is not limited hereto.

Refer to FIG. 1A and FIG. 1B going on to illustrate the training procedure S100 of the present embodiment. At step S103, the procedure includes calculating, with an encoder 105, a first embedding 115a of the first training speech sample 113a. In the present embodiment, the encoder 105 utilizes an acoustic feature generator (e.g., vq-wav2vec model), to fetch an acoustic feature from the first training speech sample 113a. Here, the procedure of fetching an acoustic feature can include projecting an original speech waveform of the first training speech sample 113a into a latent space to obtain a latent feature, and perform vector quantization to the latent feature (e.g., through the Gumbel-Softmax method) and map to a codebook vector, and so on. Furthermore, the encoder 105 also includes a GRU model and/or a Transformer model to transform the acoustic feature fetched form the first training speech sample 113a into an embedding P, to generate the first embedding 115a. It is noteworthy that the GRU model and the Transformer model can be implemented alone or in combination. It should be noted that although a vq-wav2vec model is used in the present embodiment as the acoustic feature generator, but other acoustic feature generators (e.g., convolutional neural network (CNN), hand-crafted features, wav2vec2, Speech2Vec and DeCoAR 2.0) can also be used in different embodiments to fetch the acoustic feature, the above example models can be implemented alone or in combination, the present invention is not limited hereto.

Continued with reference to FIG. 1C going on to illustrate, at step S105, the procedure includes calculating respectively, with the encoder 105, sample embeddings 115 of the training speech samples 113 of each of the basic emotion categories 110. As described before, each of the basic emotion categories 110 including the marked plurality of training speech samples 113, the embeddings of the training speech samples 113 can be calculated respectively in this step by the encoder 105 as described before, to generate the plurality of sample embeddings 115. At step S107, the procedure includes calculating a center-of-mass representation Cₖ of each of the basic emotion categories 110, wherein the center-of-mass representations Cₖ are respectively averages of the sample embeddings 115 of the different basic emotion categories 110. The calculation formula of the center-of-mass representations Cₖ is as follows:

$${C}_{k} = \frac{1}{N - 1} {Σ}_{i = 1}^{N - 1} {P}_{k , i} \qquad ( 1 )$$

wherein each of the basic emotion categories 110 has N training speech samples 113, and Cₖ indicates the center-of-mass representation of the k-th basic emotion category 110 (e.g., C₁, C₂, C₃, C₄); P_{k,i} indicates the sample embedding 115 of the i-th training speech sample 113 of the k-th basic emotion category 110.

At step S109, the procedure includes calculating respectively a cosine similarity of the first embedding 115a with the center-of-mass representation Cₖ of each of the basic emotion categories 110, wherein an angular margin is added to the cosine similarity when calculating the cosine similarity with the first emotion category 111, and the angular margin is negative. And at step S111, the procedure includes calculating a loss according to a loss function, to adjust a plurality of parameters of the emotion recognition model 103, wherein the loss function is associated with the cosine similarity. First, refer to the calculation formula of the cosine similarity as follows:

$${S}_{j , k} = w \cdot cos ( {P}_{j , i} , {C}_{k} ) + b \qquad ( 2 )$$

wherein S_{j,k} indicates the cosine similarity of the embedding of the j-th emotion category with the center-of-mass representation of the k-th basic emotion category 110; and the formula of the loss function is as follows:

$$L = {L}_{c e} - \frac{1}{K} {\sum }_{j = 1}^{K} log \frac{{e}^{{s}_{j , j}}}{{Σ}_{k = 1}^{K} {e}^{{s}_{j , k}}} \qquad ( 3 )$$

wherein L indicates the loss calculated through the loss function, L_{ce} is cross-entropy loss. Since the first emotion category 111 is also included in the basic emotion categories 110, according to the foresaid formulas, calculating the cosine similarity may contain two situations, i.e., the first emotion category 111 is the same as the basic emotion categories 110 and the first emotion category 111 is different from the basic emotion categories 110. To be specific, assuming the first emotion category 111 to be anger, basic emotion categories 110 including anger, happiness, neutral and sad, then S_{j,j} indicates the cosine similarity between the first embedding 115a of the first emotion category 111 (anger) and the center-of-mass representation Cₖ of anger of the basic emotion categories 110, while S_{j,k} also includes the cosine similarity between the first emotion category 111 (anger) and the center-of-mass representation Cₖ of other basic emotion categories 110 (happiness, neutral and sad). In this way, the loss L can be designed to decrease the distance projected to a hypersphere when the first emotion category 111 and the basic emotion categories 110 are the same, and increase the distance when the first emotion category 111 and the basic emotion categories 110 are not the same.

It should be noted that although the first emotion category 111 is taken to be anger as an exemplary illustration in the present embodiment, but in a process of calculating the loss to adjust parameters of the emotion recognition model 103, first emotion category 111 is not a fixed emotion category, but can be any emotion category in the basic emotion categories 110, and cosine similarities of the first embedding 115a of the first emotion category 111 with center-of-mass representations Cₖ of the basic emotion categories 110 are calculated respectively. For example, the first emotion category 111 is happiness, the first training speech sample 113a is a speech sample marked as happiness, after the first embedding 115a of the first training speech sample 113a is calculated by the encoder 105, cosine similarities between the first embedding 115a and center-of-mass representations Cₖ of the basic emotion categories 110 (anger, happiness, neutral and sad) are calculated respectively; or the first emotion category 111 is neutral or sad and so on, which will not be listed one by one herein for the sake of concisely illustrating the present invention.

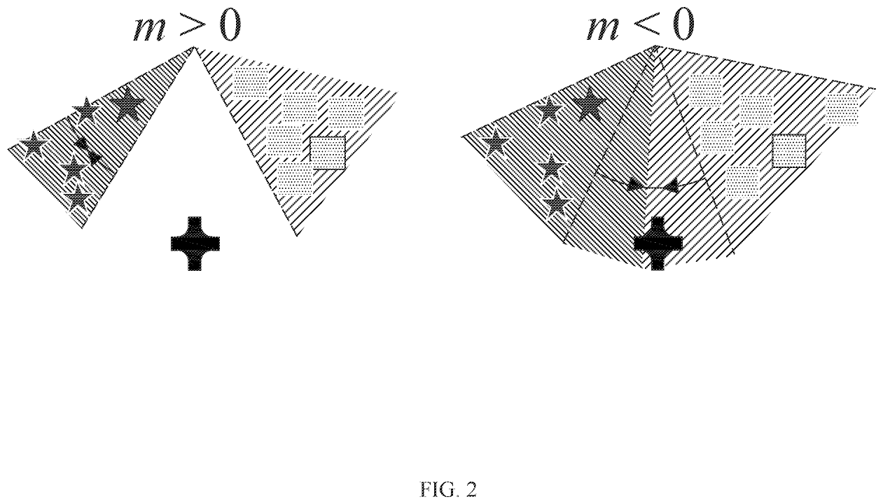

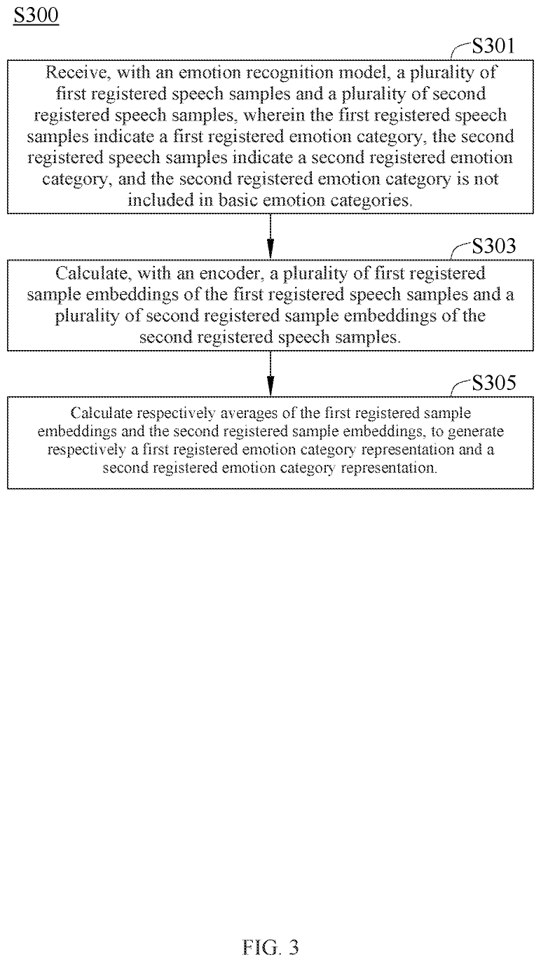

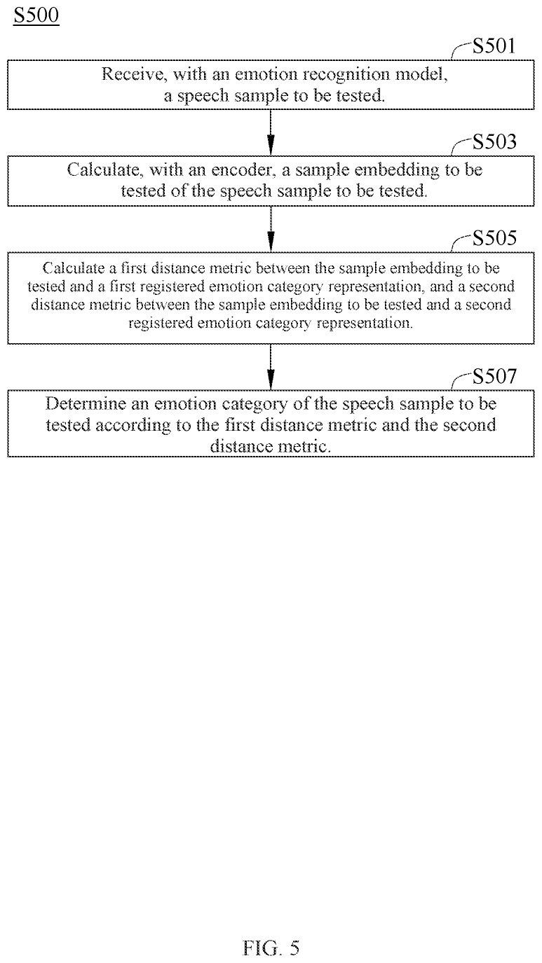

Refer to FIG. 2 going on to illustrate, although it is illustrated in the foresaid content that the loss can be designed so that the distance among same categories in the space is decreased while the distance among different categories is increased, but excessive concentration of distributions of same categories and dispersion of those of different categories may result in overly dispersed distributions of unknown emotion categories, in turn reducing the ability to represent unknown emotion categories. Therefore, when the first emotion category 111 is the same as the basic emotion categories 110 in the present invention, the calculation formula of cosine similarities also includes an angular margin, and the angular margin is negative, the formula being as follows:

$${S}_{j , k} = \{ \begin{matrix}w \cdot ( cos ( {P}_{j , i} , {C}_{k} ) + m ) & j = k \\ w \cdot cos ( {P}_{j , i} , {C}_{k} ) & j \neq k\end{matrix} \qquad ( 4 )$$

wherein m is angular margin, and m<0. By incorporating a negative angular margin m in the formula of cosine similarity, overly dispersed distances between different emotion categories can be balanced, so that boundaries of distributions of same emotion categories may be expanded. Refer to FIG. 2 showing a schematic diagram of emotion category distributions in the space, when the angular margin m is positive (left diagram of FIG. 2), the distribution between emotion categories (star signs and square signs) has a blank area, and when the angular margin m is negative (right diagram of FIG. 2), boundaries of the emotion category distributions are expanded so as to encompass the unknown emotion category (cross sign) that may exist between them. By this configuration, when the emotion recognition model 103 having undergone the training procedure S100 receives speech samples, even if the speech samples contain unknown emotion categories, representation of the unknown emotion categories can also be obtained through the encoder 105, further facilitating the subsequent register procedure S300 (see FIG. 3) and verification procedure S500 (see FIG. 5).

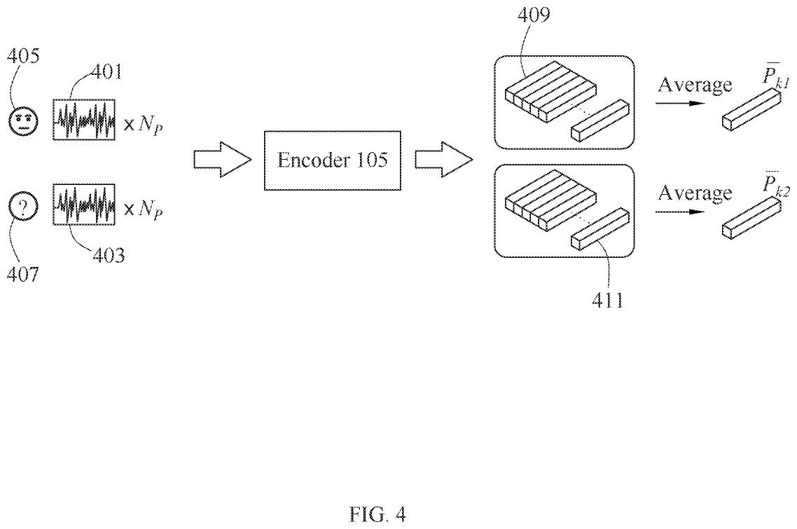

Refer to FIG. 3 and FIG. 4 illustrating a register procedure S300 of an emotion recognition method of an embodiment of the present invention. At step S301, the procedure includes receiving, with the emotion recognition model 103, a plurality of first registered speech samples 401 and a plurality of second registered speech samples 403, wherein the first registered speech samples 401 indicate a first registered emotion category 405, the second registered speech samples 403 indicate a second registered emotion category 407, and the second registered emotion category 407 is not included in the basic emotion categories 110. In this step, the emotion recognition model 103 can receive speech samples of a marked emotion category, and the emotion category can be a category other than the basic emotion categories 110; in the present embodiment for example, the first registered emotion category 405 can be neutral, the second registered emotion category 407 can be frustration. Furthermore, sample numbers of the first registered speech samples 401 and the second registered speech samples 403 do not need to be as large as that for training the emotion recognition model 103 in the training procedure S100, but only need small numbers of samples.

As above, at step S303, the procedure includes calculating, with the encoder 105, a plurality of first registered sample embeddings 409 of the first registered speech samples 401 and a plurality of second registered sample embeddings 411 of the second registered speech samples 403. As described in the training procedure S100, due to the introduction of a negative angular margin in the formula of cosine similarity, boundaries of the basic emotion categories 110 in the space are expanded, further encompassing possible unknown emotion categories. Therefore, even if the second registered emotion category 407 does not belong to the basic emotion categories 110, the second registered sample embeddings 411 of the second registered speech samples 403 can still be calculated by the encoder 105 of the foresaid trained emotion recognition model 103. At step S305, the procedure includes calculating respectively averages of the first registered sample embeddings 409 and the second registered sample embeddings 411, to generate respectively a first registered emotion category representation P̅ₖ₁ and a second registered emotion category representation P̅ₖ₂. Here, the way of calculating the first registered emotion category representation P̅ₖ₁ and the second registered emotion category representation P̅ₖ₂ is similar to calculating center-of-mass representations Cₖ, i.e., the summation of the first registered sample embeddings 409 divided by the sample number (e.g., Nₚ) of the first registered speech samples 401, and the summation of the second registered sample embeddings 411 divided by the sample number (e.g., Nₚ) of the second registered speech samples 403. It should be noted that although only the first registered emotion category 405 and the second registered emotion category 407 are exemplified in the present embodiment, but the emotion categories to perform the register procedure S300 can be more than two, like registering all of the basic emotion categories 110 (anger, happiness, neutral) and more than one unknown emotion category, and so on.

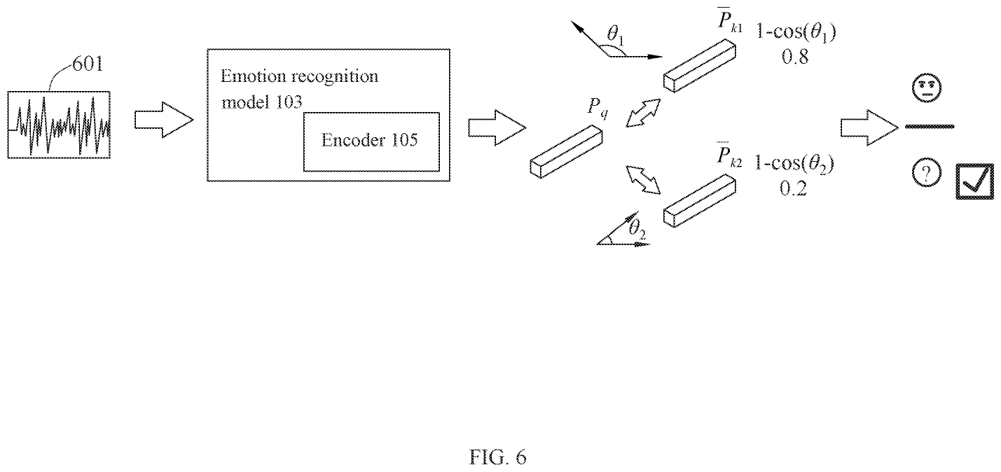

Refer to FIG. 5 and FIG. 6 illustrating a verification procedure S500 of an emotion recognition method of an embodiment of the present invention. At step S501, the procedure includes receiving, with the emotion recognition model 103, a speech sample to be tested 601. And at step S503, the procedure includes calculating, with the encoder 105, a sample embedding to be tested of the speech sample to be tested 601. Refer to the showing by FIG. 6, the speech sample to be tested 601 being a speech sample of an unmarked emotion category, a sample embedding to be tested P_{q} of the speech sample to be tested 601 can be calculated by the encoder 105 of the emotion recognition model 103 having undergone the training procedure S100 and the register procedure S300. At step S505, the procedure includes calculating a first distance metric between the sample embedding to be tested P_{q} and the first registered emotion category representation P̅ₖ₁, as well as a second distance metric between the sample embedding to be tested P_{q} and the second registered emotion category representation P̅ₖ₂. In the present embodiment, the way of calculating distance metrics is to calculate the cosine distance between the two; assuming the included angle between P_{q} and P̅ₖ₁ as θ₁, the included angle between P_{q} and P̅ₖ₂ as θ₂, then the first distance metric between the sample embedding to be tested P_{q} and the first registered emotion category representation P̅ₖ₁ is 1−cos(θ₁), and the second distance metric between the sample embedding to be tested P_{q} and the second registered emotion category representation P̅ₖ₂ is 1−cos(θ₂). It should be noted that although distance metrics are calculated with the formula of cosine distance in the present embodiment, but in different embodiments, distance metrics can also be calculated using other appropriate distance calculation methods (e.g., Euclidean distance, Manhattan distance, mutual information or Kullback-Leibler divergence, etc.), the present invention is not limited hereto.

Continuing to illustrate the present embodiment as above, at step S507, the procedure includes determining an emotion category of the speech sample to be tested 601 according to the first distance metric and the second distance metric. In the present embodiment, determining the emotion category of the speech sample to be tested 601 includes determining the emotion category as the first registered emotion category 405 according to the first distance metric being smaller than the second distance metric, or determining the emotion category as the second registered emotion category 407 according to the second distance metric being smaller than the first distance metric. For example, assuming the value of the first distance metric 1−cos(θ₁) to be 0.8, and the value of the second distance metric 1−cos(θ₂) to be 0.2, since the first distance metric is larger than the second distance metric (i.e., the speech sample to be tested 601 is closer to the second registered emotion category 407), then the emotion category of the speech sample to be tested 601 is predicted to be the second registered emotion category 407. It should be noted that although only the first distance metric and the second distance metric are compared in the present embodiment, but as described in the illustration of the register procedure S300, the present invention can register more than two emotion categories; when registering more than two emotion categories, the sample embedding to be tested of the speech sample to be tested 601 and the distance metric of each registered emotion category representation are calculated respectively, and the one with the smallest distance metric is taken as the prediction of the emotion category of the speech sample to be tested 601.

By introducing a negative angular margin in the formula of calculating cosine similarity in the foresaid training procedure S100, so that boundaries of distributions of the basic emotion categories 110 in the space are expanded, the emotion recognition model 103 is so configured that when facing new emotion recognition tasks, in the case of receiving only a small number of speech samples of the emotion category, the encoder 105 can be used to calculate the embedding of the new emotion category to perform the register procedure S300, without re-collecting a large number of speech samples and retraining the emotion recognition model 103 through the training procedure S100. And by the verification procedure S500, the emotion recognition model 103 can accomplish recognition tasks of new emotion categories through calculating distance metrics with ease, thereby achieving the objective of cross-task unseen emotion class recognition of the present invention.

An emotion recognition system of another embodiment of the present invention includes a memory and a processor, the memory being used for storing the emotion recognition model and a plurality of instructions that, when executed, configure the processor to perform an emotion recognition method of any one of the foresaid embodiments. Here, the processor can include any appropriate hardware device, such as central processing unit (CPU), microcontroller and application-specific integrated circuit (ASIC) and so on, and the memory can be appropriate storage media such as random access memory (RAM), flash memory and so on, the present invention is not limited hereto. Furthermore, a computer-readable storage medium of still another embodiment of the present invention includes a computer-readable program that, after being read by a computer, may perform an emotion recognition method of any one of the embodiments as described before.

The above-mentioned disclosure is only the preferred embodiment of the present invention, is not intended to limit the claims of the present invention, and the orders in the methods described herein are also only exemplary illustrations, a person of ordinary skill in the art can modify the orders of steps under equivalent concepts of the present invention. Furthermore, unless there is a clear contradiction with the contents herein, the singular terms “a” and “the” used herein also include plural cases, and terms such as “first” and “second” are also intended to facilitate a person of ordinary skill in the art to understand the concepts of contents of the present invention, rather than to limit the nature of the elements in the present invention. The shape, position and size of each element, component and unit in the appended drawings are intended to concisely and clearly show the technical contents of the present invention, rather than to limit the present invention. Also, well-known details or constructions may be omitted in the drawings.

### REFERENCE NUMERALS

101: emotion database
103: emotion recognition model
105: encoder
110: basic emotion categories
111: first emotion category
113: training speech samples
113a: first training speech sample
115: sample embeddings
115a: first embedding
401: first registered speech samples
403: second registered speech samples
405: first registered emotion category
407: second registered emotion category
409: first registered sample embeddings
411: second registered sample embeddings
601: speech sample to be tested
S100: training procedure
S101: step
S103: step
S105: step
S107: step
S109: step
S111: step
S300: register procedure
S301: step
S303: step
S305: step
S500: verification procedure
S501: step
S503: step
S505: step
S507: step

What is claimed is:

1. A method for unseen emotion class recognition, comprising:
receiving, with an emotion recognition model, a speech sample to be tested;
calculating, with an encoder, a sample embedding to be tested of the speech sample to be tested;
calculating a first distance metric between the sample embedding to be tested and a first registered emotion category representation, and a second distance metric between the sample embedding to be tested and a second registered emotion category representation, wherein the second registered emotion category is not included in a plurality of basic emotion categories; and
determining an emotion category of the speech sample to be tested according to the first distance metric and the second distance metric.

2. The method of claim 1, wherein determining the emotion category of the speech sample to be tested comprises: determining the emotion category as the first registered emotion category according to the first distance metric being smaller than the second distance metric, or determining the emotion category as the second registered emotion category according to the second distance metric being smaller than the first distance metric.

3. The method of claim 1, wherein the encoder comprises an acoustic feature generator to fetch an acoustic feature from the speech sample to be tested.

4. The method of claim 3, wherein the encoder comprises a GRU model and a Transformer model to transform the acoustic feature into the sample embedding to be tested.

5. The method of claim 1, further comprising a register procedure which comprises:
receiving, with the emotion recognition model, a plurality of first registered speech samples and a plurality of second registered speech samples, wherein the first registered speech samples indicate the first registered emotion category and the second registered speech samples indicate the second registered emotion category;
calculating, with the encoder, a plurality of first registered sample embeddings of the first registered speech samples and a plurality of second registered sample embeddings of the second registered speech samples; and
calculating respectively averages of the first registered sample embeddings and the second registered sample embeddings, to generate respectively the first registered emotion category representation and the second registered emotion category representation.

6. The method of claim 1, further comprising a training procedure which comprises:
receiving, with the emotion recognition model, a first training speech sample, wherein the first training speech sample indicates a first emotion category in the basic emotion categories, and the basic emotion categories include respectively a plurality of training speech samples;
calculating, with the encoder, a first embedding of the first training speech sample;
calculating respectively, with the encoder, a plurality of sample embeddings of the training speech samples of each of the basic emotion categories;
calculating a center-of-mass representation of each of the basic emotion categories, wherein the center-of-mass representations are respectively averages of the sample embeddings of different basic emotion categories;
calculating respectively a cosine similarity of the first embedding with the center-of-mass representation of each of the basic emotion categories, wherein an angular margin is added to the cosine similarity when calculating the cosine similarity with the first emotion category, and the angular margin is negative; and
calculating a loss according to a loss function, to adjust a plurality of parameters of the emotion recognition model, wherein the loss function is associated with the cosine similarity.

7. The method of claim 6, wherein the loss function includes a cross-entropy loss.

8. A system for unseen emotion class recognition, comprising:
a memory having stored thereon a plurality of instructions; and
a processor coupled to the memory, wherein the processor is configured to, when executing the instructions:
receive, with an emotion recognition model, a speech sample to be tested;
calculate, with an encoder, a sample embedding to be tested of the speech sample to be tested;
calculate a first distance metric between the sample embedding to be tested and a first registered emotion category representation, and a second distance metric between the sample embedding to be tested and a second registered emotion category representation, wherein the second registered emotion category is not included in a plurality of basic emotion categories; and
determine an emotion category of the speech sample to be tested according to the first distance metric and the second distance metric.

9. The system of claim 8, wherein the processor is configured to: determine the emotion category of the speech sample to be tested as the first registered emotion category according to the first distance metric being smaller than the second distance metric, or determine the emotion category as the second registered emotion category according to the second distance metric being smaller than the first distance metric.

10. The system of claim 8, wherein the encoder comprises an acoustic feature generator to fetch an acoustic feature from the speech sample to be tested.

11. The system of claim 10, wherein the encoder comprises a GRU model and a Transformer model to transform the acoustic feature into the sample embedding to be tested.

12. The system of claim 8, wherein the processor is further configured to:
receive, with the emotion recognition model, a plurality of first registered speech samples and a plurality of second registered speech samples, wherein the first registered speech samples indicate the first registered emotion category and the second registered speech samples indicate the second registered emotion category;
calculate, with the encoder, a plurality of first registered sample embeddings of the first registered speech samples and a plurality of second registered sample embeddings of the second registered speech samples; and
calculate respectively averages of the first registered sample embeddings and the second registered sample embeddings, to generate respectively the first registered emotion category representation and the second registered emotion category representation.

13. The system of claim 8, wherein the processor is further configured to:
receive, with the emotion recognition model, a first training speech sample, wherein the first training speech sample indicates a first emotion category in the basic emotion categories, and the basic emotion categories include respectively a plurality of training speech samples;
calculate, with the encoder, a first embedding of the first training speech sample;
calculate respectively, with the encoder, a plurality of sample embeddings of the training speech samples of each of the basic emotion categories;
calculate a center-of-mass representation of each of the basic emotion categories, wherein the center-of-mass representations are respectively averages of the sample embeddings of different basic emotion categories;
calculate respectively a cosine similarity of the first embedding with the center-of-mass representation of each of the basic emotion categories, wherein an angular margin is added to the cosine similarity when calculating the cosine similarity with the first emotion category, and the angular margin is negative; and
calculate a loss according to a loss function, to adjust a plurality of parameters of the emotion recognition model, wherein the loss function is associated with the cosine similarity and includes a cross-entropy loss.

14. A computer-readable storage medium for unseen emotion class recognition loaded with a computer-readable program capable of, after being read by a computer, configure the computer to:
receive, with an emotion recognition model, a speech sample to be tested;
calculate, with an encoder, a sample embedding to be tested of the speech sample to be tested;
calculate a first distance metric between the sample embedding to be tested and a first registered emotion category representation, and a second distance metric between the sample embedding to be tested and a second registered emotion category representation, wherein the second registered emotion category is not included in a plurality of basic emotion categories; and
determine an emotion category of the speech sample to be tested according to the first distance metric and the second distance metric.

15. The computer-readable storage medium of claim 14, wherein the computer-readable program is capable of, after being read by the computer, configure the computer to: determine the emotion category of the speech sample to be tested as the first registered emotion category according to the first distance metric being smaller than the second distance metric, or determine the emotion category as the second registered emotion category according to the second distance metric being smaller than the first distance metric.

16. The computer-readable storage medium of claim 14, wherein the encoder comprises an acoustic feature generator to fetch an acoustic feature from the speech sample to be tested.

17. The computer-readable storage medium of claim 16, wherein the encoder comprises a GRU model and a Transformer model to transform the acoustic feature into the sample embedding to be tested.

18. The computer-readable storage medium of claim 14, wherein the computer-readable program is capable of, after being read by the computer, further configure the computer to:
receive, with the emotion recognition model, a plurality of first registered speech samples and a plurality of second registered speech samples, wherein the first registered speech samples indicate the first registered emotion category and the second registered speech samples indicate the second registered emotion category;
calculate, with the encoder, a plurality of first registered sample embeddings of the first registered speech samples and a plurality of second registered sample embeddings of the second registered speech samples; and
calculate respectively averages of the first registered sample embeddings and the second registered sample embeddings, to generate respectively the first registered emotion category representation and the second registered emotion category representation.

19. The computer-readable storage medium of claim 14, wherein the computer-readable program is capable of, after being read by the computer, further configure the computer to:
receive, with the emotion recognition model, a first training speech sample, wherein the first training speech sample indicates a first emotion category in the basic emotion categories, and the basic emotion categories include respectively a plurality of training speech samples;
calculate, with the encoder, a first embedding of the first training speech sample;
calculate respectively, with the encoder, a plurality of sample embeddings of the training speech samples of each of the basic emotion categories;
calculate a center-of-mass representation of each of the basic emotion categories, wherein the center-of-mass representations are respectively averages of the sample embeddings of different basic emotion categories;
calculate respectively a cosine similarity of the first embedding with the center-of-mass representation of each of the basic emotion categories, wherein an angular margin is added to the cosine similarity when calculating the cosine similarity with the first emotion category, and the angular margin is negative; and
calculate a loss according to a loss function, to adjust a plurality of parameters of the emotion recognition model, wherein the loss function is associated with the cosine similarity and includes a cross-entropy loss.
